(19) United States
(12) Patent Application Publication
(10) Pub. No.: US 2001/0051866 A1
(43) Pub. Date: Dec. 13, 2001

(54) Tracing circuit, tracing method and record medium for operation monitoring device

(75) Inventor: Yasumasa Ishii, Kanagawa (JP)

Correspondence Address: FOLEY & LARDNER, Washington Harbour, 3000 K Street, N.W., Suite 500, P.O. Box 25696, Washington, DC, 20007-8696, US

(73) Assignee: NEC CORPORATION.

(21) Appl. No.: 09/736,370

(22) Filed: Dec. 15, 2000

(30) Foreign Application Priority Data
Dec. 17, 1999 (JP) 11-359970

(51) Int. Cl. G06F 9/455

(52) U.S. Cl. 703/28; 711/5

(57) ABSTRACT

Trace data outputted by an evaluation chip of a tracing circuit of an in-circuit emulator are successively written into a current bank of a trace memory cyclically. When trace data that matches a designated access event is outputted by the evaluation chip, the trace data corresponding to the designated access event is written into the current bank (#1) of the trace memory and thereafter the write pointer is moved to the front end of the next bank (#2). Thereafter, the trace data writing into the current bank (#2) is repeated cyclically. When trace data that matches a designated fetch event is outputted by the evaluation chip, the trace data corresponding to the designated fetch event is written into the current bank (#2) of the trace memory and thereafter the write pointer is moved to the front end of the next bank (#3). Subsequently, the trace data writing into the current bank (#3) is continued to the rear end of the current bank (#3), and thereafter the write pointer is moved to the front end of the next bank (#4), without executing the loop writing to the current bank (#3) (delay function). By the operation of the tracing circuit, “fetch data” and “access result” corresponding to the “fetch data” can certainly be preserved in the trace memory (without being deleted by the overwriting) and displayed as a pair even when pipeline processing is executed by the CPU of the evaluation chip, without the need of a large storage capacity of the trace memory.

### BACKGROUND OF THE INVENTION

The present invention relates to a tracing method for an operation monitoring device such as an in-circuit emulator (ICE), a logic analyzer, etc., a tracing circuit of the operation monitoring device, and a record medium storing a program for implementing the tracing method.

Description of the Related Art

Operation monitoring devices such as in-circuit emulators (ICEs), logic analyzers, etc. are generally used today for monitoring or evaluating the operation of devices. The in-circuit emulators including evaluation chips are used for evaluating the operation of circuit boards including MPUs (MicroProcessor Units). For example, an MPU (including a CPU (Central Processing Unit), ROM (Read Only Memory), RAM (Random Access Memory), etc.) storing a program for an electrical appliance (such as an air conditioner) is removed from a circuit board of the electrical appliance, and an in-circuit emulator including an evaluation chip (having the same pin arrangement and the same CPU as the removed MPU) is mounted on the circuit board of the electrical appliance in place of the original MPU. The evaluation chip is usually provided with a rewritable memory, and the program of the MPU for the electrical appliance and a program for the evaluation are written in the rewritable memory. The in-circuit emulator operates in the same way as the original MPU of the electrical appliance, and the evaluation of the program stored in the MPU is conducted, for example.

The evaluation chip of the in-circuit emulator, which is mounted on the circuit board in place of the original MPU, is usually provided with functions for outputting data for the evaluation such as “fetch data”, “access result”, etc. The “fetch data” includes a memory address (fetch address) (to which an instruction fetch has been executed) and an instruction code (which has been fetched from the fetch address in the fetch event), for example. The “access result” includes a memory address (to which a read/write access has been executed due to the execution of the instruction code) and data (which has been read/written from/into the memory address), for example. When an instruction fetch is executed (that is, when a fetch event occurred), the evaluation chip outputs the “fetch data” and interprets the fetched instruction code. When the interpretation of the instruction code is finished, a memory access (memory read or write) due to the execution of the instruction code is conducted (that is, an access event occurs). When an access event occurred, the evaluation chip outputs the “access result”. The “fetch data” and the “access result” outputted by the evaluation chip is stored in a trace memory (that is, tracing is executed.) for the evaluation. The tracing method can be roughly classified into “all trace”, “section trace” and “qualify trace”. In the section trace, the tracing is executed with regard to a fetch event and/or an access event to a section of the memory (address 100 through address 200, for example). In the qualify trace, the tracing is executed with regard to a fetch event and/or an access event to a predetermined memory address (address 100, for example). In the all trace, the tracing is executed with regard to all addresses of the memory and all the fetch data and all the access results outputted by the evaluation chip is traced, that is, stored in the trace memory.

The tracing can be conducted with regard to fetch events and/or access events. The user of the in-circuit emulator can select events to be traced. The in-circuit emulator judges that a fetch/access event which has been set by the user occurred, when the output of the evaluation chip (i.e. fetch data or access result) matched a preset reference data which is used for event comparison. The reference data, which is set by the user before the evaluation, can be set with regard to one or more addresses, a specific type of event, a combination of address and event, etc. For example, the reference data to be used for the event comparison includes: “any event with regard to address 100”, “data reading from address 100”, “data writing to address 100”, “instruction fetch from address 100”, “data reading of data AA”, “data writing of data AA” “data reading/writing of data AA”, etc.

FIG. 1 is a schematic diagram showing the operation of an in-circuit emulator (data outputted by an evaluation chip and data written into a trace memory) in the qualify trace when pipeline processing is not executed by the CPU, and FIG. 2 is a schematic diagram showing the operation of the in-circuit emulator in the qualify trace when pipeline processing is executed by the CPU. Both in FIGS. 1 and 2, the qualify trace is executed with regard to address 100 fetch (an instruction fetch to memory address 100). FIG. 3 is a schematic diagram showing the operation of the in-circuit emulator when the all trace is executed.

In the example of FIG. 1, fetch and execution (i.e. the “fetch data” and the “access result” corresponding to the “fetch data”) are traced in the same frame of the trace memory on the same time axis, thereby the fetch data and the access result with regard to the address 100 fetch can be traced for the evaluation successfully.

However, in the case of FIG. 2 where the CPU executes pipeline processing, the fetch data and the access result are not outputted by the evaluation chip on the same time axis, that is, the access result is not outputted just after the fetch data (see (A) of FIG. 2). Therefore, if the conventional qualify trace is simply executed, only the fetch data of the address 100 fetch is traced in the trace memory, and the access result due to the address 100 fetch is not stored in the trace memory. The user of the in-circuit emulator who is conducting the evaluation actually needs the fetch data and the access result as a pair.

The all trace which is shown in FIG. 3 has been known as a method for displaying the fetch data and the access result as a pair even in the case where the CPU executes pipeline processing. Referring to FIG. 3, all the data (fetch data and access results) outputted by the evaluation chip is traced (written in the trace memory) as shown in (B) of FIG. 3. Data to be displayed to the user is selected by software by establishing association between fetch data and a corresponding access result, thereby the fetch data and the access result with regard to the address 100 fetch can be displayed to the user as shown in (C) of FIG. 3 even when the pipeline processing is executed by the CPU, in the same GUI (graphical user interface) as the case of the qualify trace of FIG. 1 where the pipeline processing is not executed by the CPU.

However, in the all trace shown in FIG. 3, memory consumption is very large and the trace memory can not be used efficiently. The trace memory is required to have a very large size in order to conduct tracing of all the trace data outputted by the evaluation chip.

In order to eliminate the above memory consumption problem of the all trace, there have been proposed some operation monitoring devices (microprocessor analyzer, tracing device, program execution history recording device, etc.) in which the trace memory is partitioned into several banks and loop writing (cyclic writing) is conducted to each bank.

In conventional operation monitoring devices (tracing device, program execution history recording device) which have been disclosed in Japanese Patent Application Laid-Open Nos.HEI05-289907 and HEI05-324396, the trace memory is partitioned into several banks, and the trace data outputted by the evaluation chip is successively written into a current bank of the trace memory. The trace data writing to the current bank (#1, for example) is conducted in a loop (cyclically). When an event which has been designated by the user (designated event) occurred, the write address (write pointer) of the trace memory is moved into the front end of the next bank (#2) and thereafter the loop writing is repeated in the current bank (#2). Thereafter, on every occurrence of the designated event, the write address (write pointer) of the trace memory is moved into the next bank (#3, #4, . . . ). By such operation, the memory consumption of the trace memory can be reduced by the loop writing, and further, the trace data concerning the event which has been designated by the user can certainly be preserved in the trace memory, without being deleted by the overwrite due to the loop writing.

In a conventional operation monitoring device (microprocessor analyzer) which has been disclosed in Japanese Patent Application Laid-Open No.HEI02-242345, the partitioning of the trace memory into banks and the loop writing are also employed, and when a designated event occurred, trace data writing is conducted in the current bank for a predetermined times (sample number) and thereafter the write address (write pointer) of the trace memory is moved into the front end of the next bank.

However, in the conventional operation monitoring devices of Japanese Patent Application Laid-Open Nos.HEI05-289907 and HEI05-324396, trace data concerning events after the designated event might be deleted due to the loop writing after the bank change. Especially, trace data written just after the bank change tends to be deleted by the overwrite in the next loop.

In the conventional operation monitoring device of Japanese Patent Application Laid-Open No.HEI02-242345, trace data concerning events before the designated event might be deleted due to the trace data writing (overwrite) which is executed after the occurrence of the designated event for the predetermined times (sample number).

### SUMMARY OF THE INVENTION

It is therefore the primary object of the present invention to provide a tracing circuit of an operation monitoring device, by which fetch data and corresponding access data can be traced and displayed as a pair even when the pipeline processing is executed by the CPU, without the need of a large storage capacity of the trace memory.

Another object of the present invention is to provide a tracing method for an operation monitoring device, by which fetch data and corresponding access data can be traced and displayed as a pair even when the pipeline processing is executed by the CPU, without the need of a large storage capacity of the trace memory.

In accordance with a first aspect of the present invention, there is provided a tracing circuit of an operation monitoring device, comprising a trace data output means, a trace memory means, a reference data storage means, an event comparison means and a trace address control means. The trace data output means outputs trace data. The trace memory means is partitioned into banks of appropriate sizes, and the trace data outputted by the trace data output means is written into the trace memory means. The reference data storage means stores reference data corresponding to a prior-preservation event and/or a posterior-preservation event which have been designated by the user of the operation monitoring device as objects of tracing. The event comparison means compares the trace data outputted by the trace data output means with the reference data corresponding to the prior-preservation event and/or the reference data corresponding to the posterior-preservation event, outputs a prior-preservation event occurrence signal if the trace data matched the reference data corresponding to the prior-preservation event, and outputs a posterior-preservation event occurrence signal if the trace data matched the reference data corresponding to the posterior-preservation event. The trace address control means controls the write address of the trace memory means so that trace data writing will be conducted to the current bank of the trace memory means cyclically by returning the write address to the front end of the current bank when the write address reached the rear end of the current bank. When the prior-preservation event occurrence signal is outputted by the event comparison means, the trace address control means moves the write address of the trace memory means to the front end of another bank after the trace data corresponding to the prior-preservation event occurrence signal is written into the current bank of the trace memory means. When the posterior-preservation event occurrence signal is outputted by the event comparison means, the trace address control means moves the write address of the trace memory means to the front end of another bank (#A) after the trace data corresponding to the posterior-preservation event occurrence signal is written into the current bank of the trace memory means, and moves the write address to the front end of still another bank (#B) if the trace data writing is finished throughout the aforementioned another bank (#A).

In accordance with a second aspect of the present invention, in the first aspect, the operation monitoring device is implemented as an in-circuit emulator (ICE), and the trace data output means is implemented as an evaluation chip of the in-circuit emulator.

In accordance with a third aspect of the present invention, in the second aspect, the prior-preservation event is an access event, and the posterior-preservation event is a fetch event.

In accordance with a fourth aspect of the present invention, in the first aspect, the operation monitoring device is implemented as a logic analyzer, and the trace data output means is implemented as an execution result output circuit of the logic analyzer.

In accordance with a fifth aspect of the present invention, in the first aspect, the trace data outputted by the trace data output means is latched by a latch in sync with a signal which is outputted by the trace data output means, and the latched trace data is written into the trace memory means.

In accordance with a sixth aspect of the present invention, there is provided a tracing method for an operation monitoring device. The tracing method comprises a reference data storage step, a trace memory partitioning step, a trace data output step, an event comparison step, a first trace address control step, a second trace address control step and a third trace address control step. In the reference data storage step, reference data corresponding to a prior-preservation event and/or a posterior-preservation event which have been designated by the user of the operation monitoring device as objects of tracing are stored in a reference data storage means. In the trace memory partitioning step, a trace memory means to which trace data outputted by a trace data output means are written is partitioned into banks of appropriate sizes. In the trace data output step, the trace data is outputted by the trace data output means. In the event comparison step, the trace data outputted by the trace data output means is compared with the reference data corresponding to the prior-preservation event and/or the reference data corresponding to the posterior-preservation event, a prior-preservation event occurrence signal is outputted if the trace data matched the reference data corresponding to the prior-preservation event, and a posterior-preservation event occurrence signal is outputted if the trace data matched the reference data corresponding to the posterior-preservation event. In the first trace address control step, the write address of the trace memory means is controlled so that trace data writing will be conducted to the current bank of the trace memory means cyclically by returning the write address to the front end of the current bank when the write address reached the rear end of the current bank. The second trace address control step is conducted when the prior-preservation event occurrence signal is outputted in the event comparison step. In the second trace address control step, the write address of the trace memory means is moved to the front end of another bank after the trace data corresponding to the prior-preservation event occurrence signal is written into the current bank of the trace memory means. The third trace address control step is conducted when the posterior-preservation event occurrence signal is outputted in the event comparison step. In the third trace address control step, the write address of the trace memory means is moved to the front end of another bank (#A) after the trace data corresponding to the posterior-preservation event occurrence signal is written into the current bank of the trace memory means, and the write address is moved to the front end of still another bank (#B) if the trace data writing is finished throughout the aforementioned another bank (#A).

In accordance with a seventh aspect of the present invention, in the sixth aspect, the operation monitoring device is implemented as an in-circuit emulator (ICE), and the trace data output means is implemented as an evaluation chip of the in-circuit emulator.

In accordance with an eighth aspect of the present invention, in the seventh aspect, the prior-preservation event is an access event, and the posterior-preservation event is a fetch event.

In accordance with a ninth aspect of the present invention, in the sixth aspect, the operation monitoring device is implemented as a logic analyzer, and the trace data output means is implemented as an execution result output circuit of the logic analyzer.

In accordance with a tenth aspect of the present invention, in the sixth aspect, the trace data outputted by the trace data output means in the trace data output step is latched in sync with a signal which is outputted by the trace data output means, and the latched trace data is written into the trace memory means.

In accordance with eleventh through fifteenth aspects of the present invention, there are provided computer-readable record mediums storing programs for instructing a computer, an MPU (MicroProcessor Unit), etc. to execute the tracing methods of the fifth through tenth aspects of the present invention.

### BRIEF DESCRIPTION OF THE DRAWINGS

The objects and features of the present invention will become more apparent from the consideration of the following detailed description taken in conjunction with the accompanying drawings, in which:

FIG. 1 is a schematic diagram showing the operation of an in-circuit emulator (data outputted by an evaluation chip and data written into a trace memory) which executes qualify trace when pipeline processing is not executed;

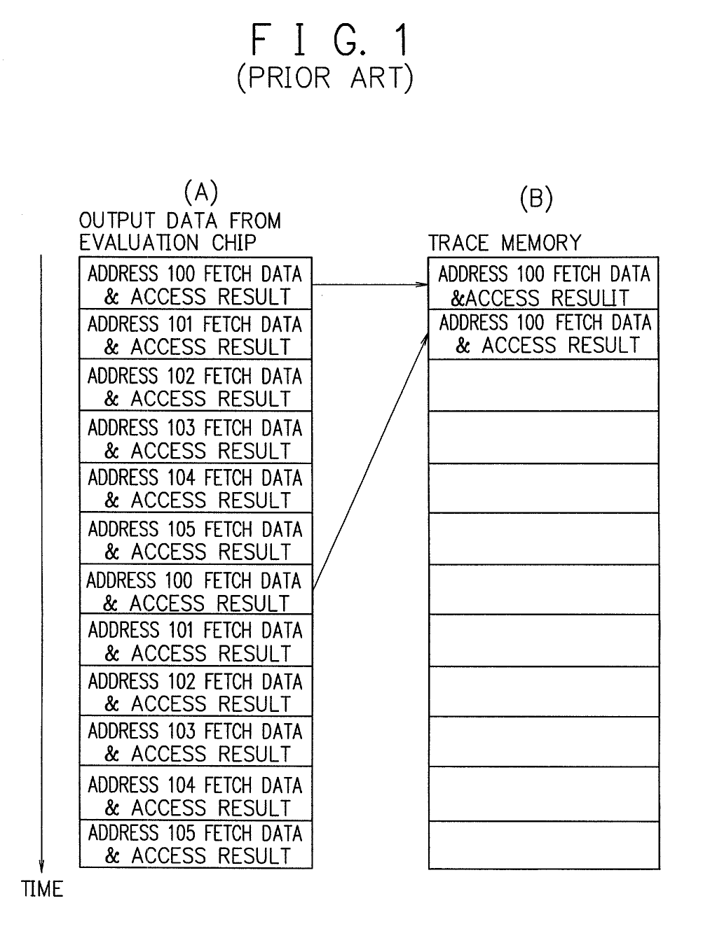

FIG. 2 is a schematic diagram showing the operation of the in-circuit emulator (data outputted by the evaluation chip and data written into the trace memory) which executes qualify trace when pipeline processing is executed;

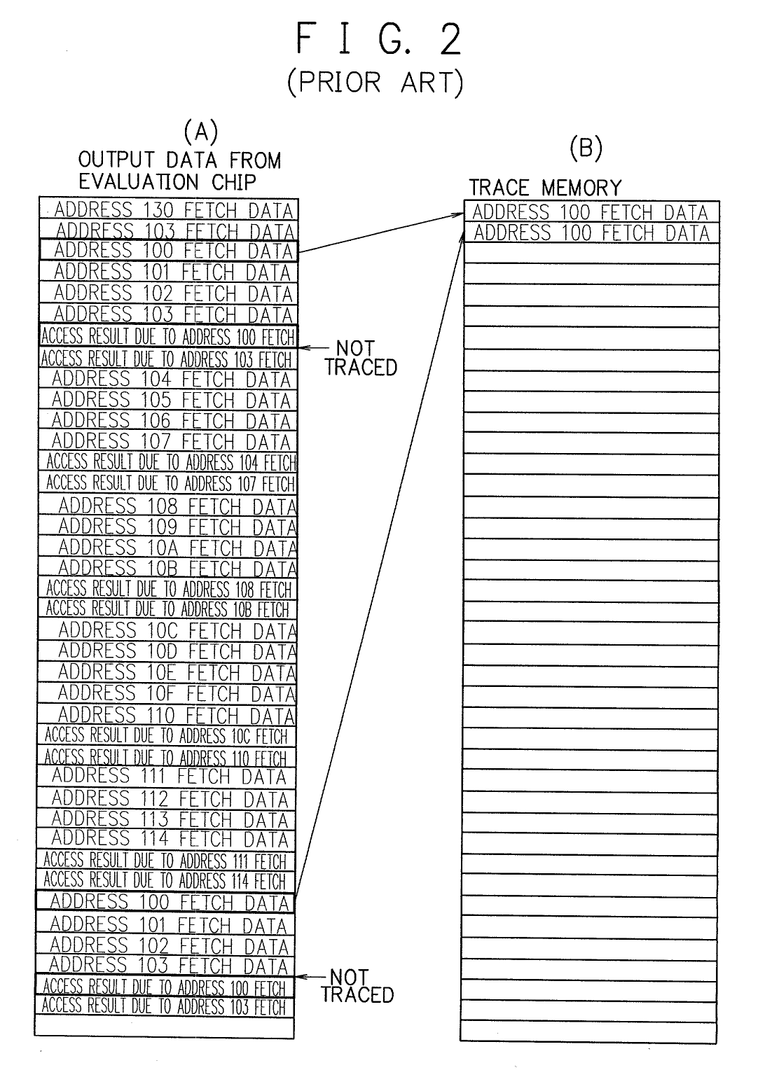

FIG. 3 is a schematic diagram showing the operation of the in-circuit emulator when all trace is executed;

FIG. 4 is a block diagram showing the basic composition of a tracing circuit of an operation monitoring device in accordance with the present invention;

FIG. 5 is a schematic diagram showing data output from an evaluation chip and data writing into a trace memory in the tracing circuit of FIG. 4;

FIG. 6 is a block diagram showing a tracing circuit of an operation monitoring device in accordance with a first embodiment of the present invention;

FIG. 7 is a timing chart showing an example of the operation of the tracing circuit of FIG. 6;

FIG. 8 is a flow chart showing an example of the operation of the tracing circuit of FIG. 6;

FIG. 9 is a schematic diagram showing an example of data output from an evaluation chip and data writing into a trace memory in the tracing circuit of FIG. 6;

FIG. 10 is a schematic diagram showing an example of qualify data information which is selected by software and shown to the user of the operation monitoring device; and

FIG. 11 is a block diagram showing a tracing circuit of an operation monitoring device in accordance with a second embodiment of the present invention.

### DESCRIPTION OF THE PREFERRED EMBODIMENTS

Referring now to the drawings, a description will be given in detail of preferred embodiments in accordance with the present invention.

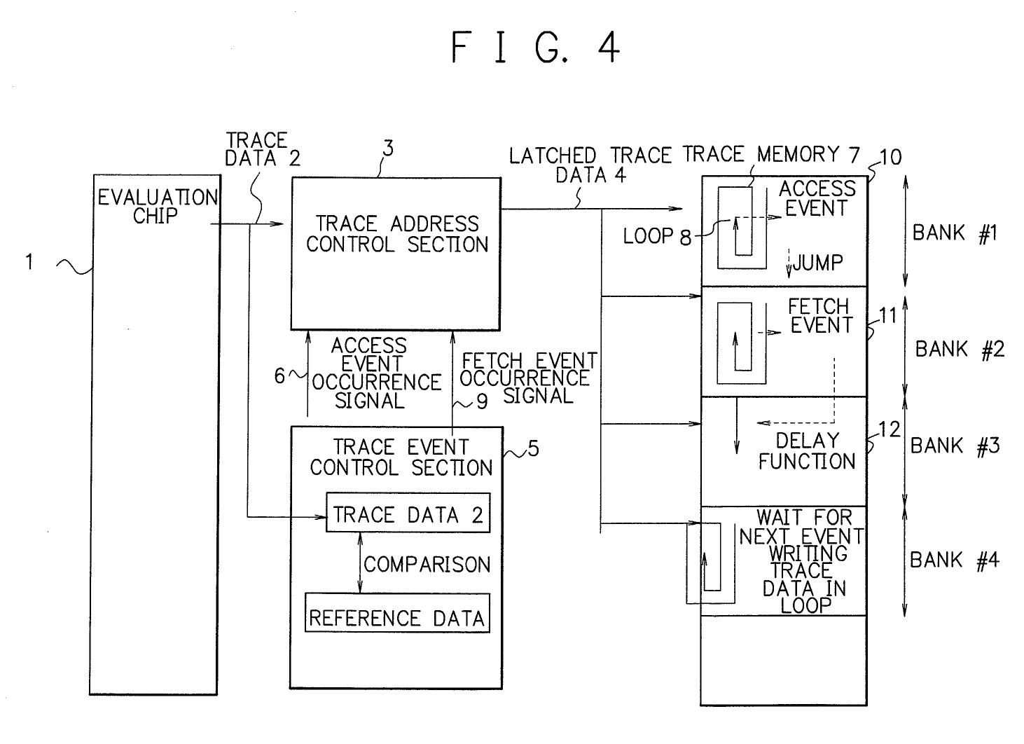

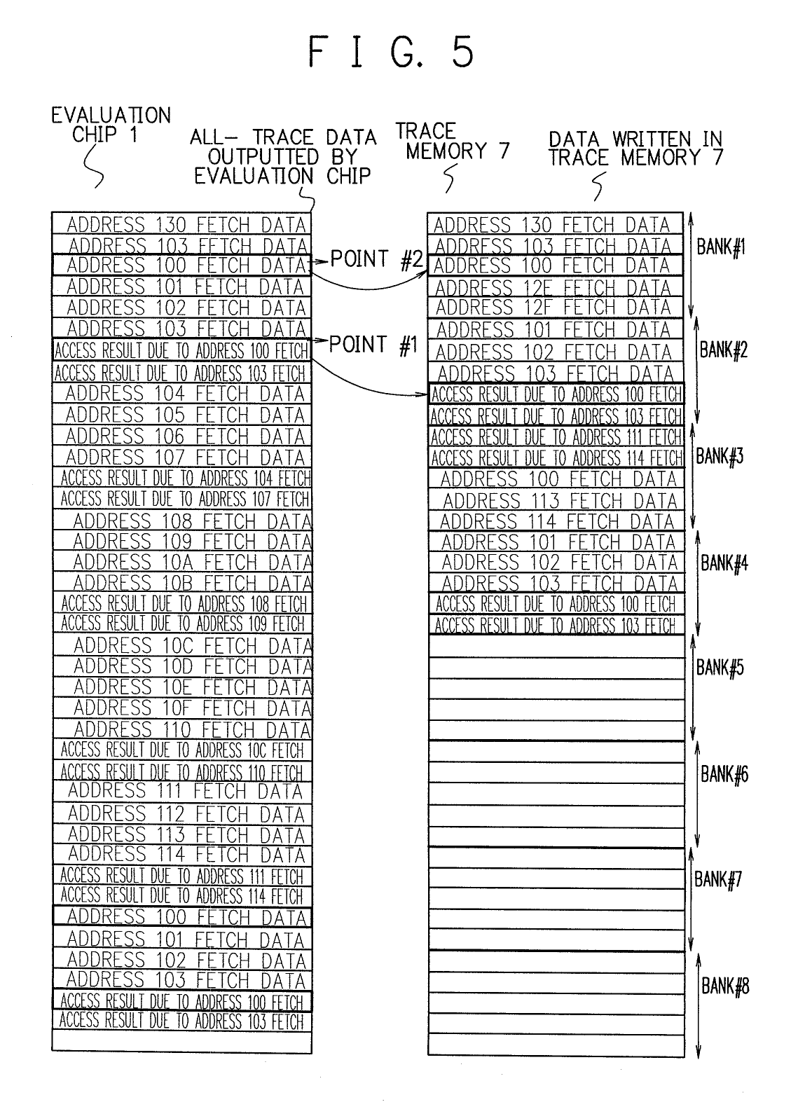

FIG. 4 is a block diagram showing the basic composition of a tracing circuit of an operation monitoring device in accordance with the present invention. The operation monitoring device, such as an in-circuit emulator, a logic analyzer, etc. is used for monitoring the operation of a device such as an electrical appliance. In the following, an explanation will be given taking a case of an in-circuit emulator as an example. FIG. 5 is a schematic diagram showing data output from an evaluation chip and data writing into a trace memory in the tracing circuit of FIG. 4.

Referring to FIG. 4, the tracing circuit includes an evaluation chip 1, a trace address control section 3, a trace event control section 5 and a trace memory 7. Trace data (all-trace data) 2 outputted by the evaluation chip 1 is inputted to the trace address control section 3 and the trace event control section 5. The trace data 2 supplied to the trace address control section 3 is latched by the trace address control section 3, and the latched trace data 4 is written in the trace memory 7.

The trace memory 7 is segmented into several banks #1, #2, . . . The latched trace data 4 outputted by the trace address control section 3 is first written into the bank #1 of the trace memory 7. The trace data writing into the current bank #1 is repeated cyclically (in a loop 8).

If we assume an access event and a fetch event have been designated by the user of the operation monitoring device (in-circuit emulator) and set (as objects of tracing) to the trace event control section 5, when trace data 2 that matches the designated access event is outputted by the evaluation chip 1, an access event occurrence signal (trigger signal) 6 is outputted by the trace event control section 5. In the case where the access event occurrence signal 6 is supplied to the trace address control section 3, the latched trace data 4 corresponding to the designated access event is written into the current bank #1 of the trace memory 7 and thereafter the write pointer for the next trace data is moved to the front end of the next bank #2. Thereafter, the trace data writing into the current bank #2 is repeated cyclically (in a loop 8).

When trace data 2 that matches the designated fetch event is outputted by the evaluation chip 1, a fetch event occurrence signal (trigger signal) 9 is outputted by the trace event control section 5. In the case where the fetch event occurrence signal 9 is supplied to the trace address control section 3, the latched trace data 4 corresponding to the designated fetch event is written into the current bank #2 of the trace memory 7 and thereafter the write pointer for the next trace data is moved to the front end of the next bank #3. Subsequently, the trace data writing into the current bank #3 is continued to the rear end of the current bank #3, and thereafter the write pointer for the next trace data is moved to the front end of the next bank #4, without executing the loop writing to the current bank #3 (hereafter, referred to as “delay function”).

The above operation is the basic feature of the present invention. In the above operation including the “delay function”, trace data concerning events before the occurrence of the designated access event could be preserved in the bank #1 of the trace memory 7 without being deleted, and trace data concerning events after the occurrence of the designated fetch event could be preserved in the bank #3 of the trace memory 7 without being deleted. In short, both trace data concerning “prior events” (events before a designated event) and trace data concerning “posterior events” (events after a designated event) could be preserved in the trace memory 7 without being deleted by the overwriting.

In the following, the trace data writing operation to the trace memory 7 will be described in detail referring to FIG. 5. The trace memory 7 shown in FIG. 5 is partitioned into eight banks (#1˜#8). The following explanation will given on the assumption that data (reference data) for qualify trace with regard to a fetch event designated by the user (address 100 fetch at the point #2 shown in FIG. 5) has been set to the trace event control section 5.

From the start of the emulation, all-trace data 2 (fetch data, access result) outputted by the evaluation chip 1 is repeatedly written in the bank #1 of the trace memory 7 in a loop 8. The tracing circuit waits for the occurrence of the designated event (of the point #2) continuing the trace data writing to the bank #1 in the loop 8. When the designated fetch event of the point #2 (that is, the address 100 fetch) occurred, the trace data (all-trace data) 2 outputted by the evaluation chip 1 matches the reference data which has been stored in the trace event control section 5, thereby the trace event control section 5 outputs the fetch event occurrence signal 9 to the trace address control section 3. In the case where the fetch event occurrence signal 9 is supplied to the trace address control section 3, the trace data 2 outputted by the evaluation chip 1 at the point #2 (address 100 fetch data) is written in the current bank #1 of the trace memory 7 and thereafter the write pointer for the next trace data is moved to the front end of the next bank #2.

Thereafter, the delay function is activated, and thereby the trace data writing is continued to the rear end of the current bank #2. Referring to the bank #2 shown in FIG. 5, trace data: “address 101 fetch data”, “address 102 fetch data”, “address 103 fetch data”, “access result due to address 100 fetch” and “access result due to address 103 fetch” are successively written in the bank #2. Thereafter, due to the delay function, the write pointer for the next trace data is moved to the front end of the next bank #3 without executing loop writing into the bank #2.

Thereafter, the loop writing is repeated in the current bank #3 waiting for the occurrence of the designated fetch event (address 100 fetch). During the loop writing, overwrite of the trace data written in the current bank #3 is repeated.

Thereafter, when the designated fetch event (that is, the address 100 fetch) occurred again, the fetch event occurrence signal 9 is outputted by the trace event control section 5. Due to the fetch event occurrence signal 9, the write pointer is moved to the front end of the next bank #4 after writing the trace data 2 corresponding to the designated fetch event (address 100 fetch data) to the current bank #3.

In the above example of FIG. 5, trace data 2: “address 100 fetch data” corresponding to the designated fetch event (address 100 fetch at the point #2) could successfully be preserved in the bank #1, and trace data 2: “access result due to address 100 fetch” (at point #1) could also be preserved in the bank #2 successfully without being deleted. The preservation of the trace data concerning a posterior event (“access result due to address 100 fetch”) is attained due to the delay function. The number of frames (units in each of which latched trace data 4 is written) included in each bank of the trace memory 7 is determined appropriately considering the distance (in the time axis) between the “fetch data” and the “access result” corresponding to the “fetch data”. By the appropriate setting of the frame number, memory consumption due to unnecessary trace data stored in the trace memory 7 can be reduced while ensuring the preservation of necessary trace data.

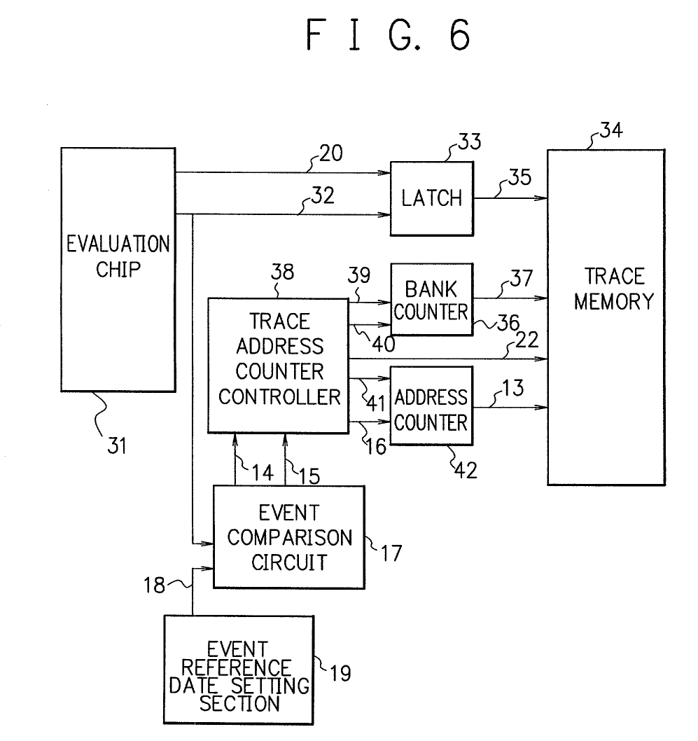

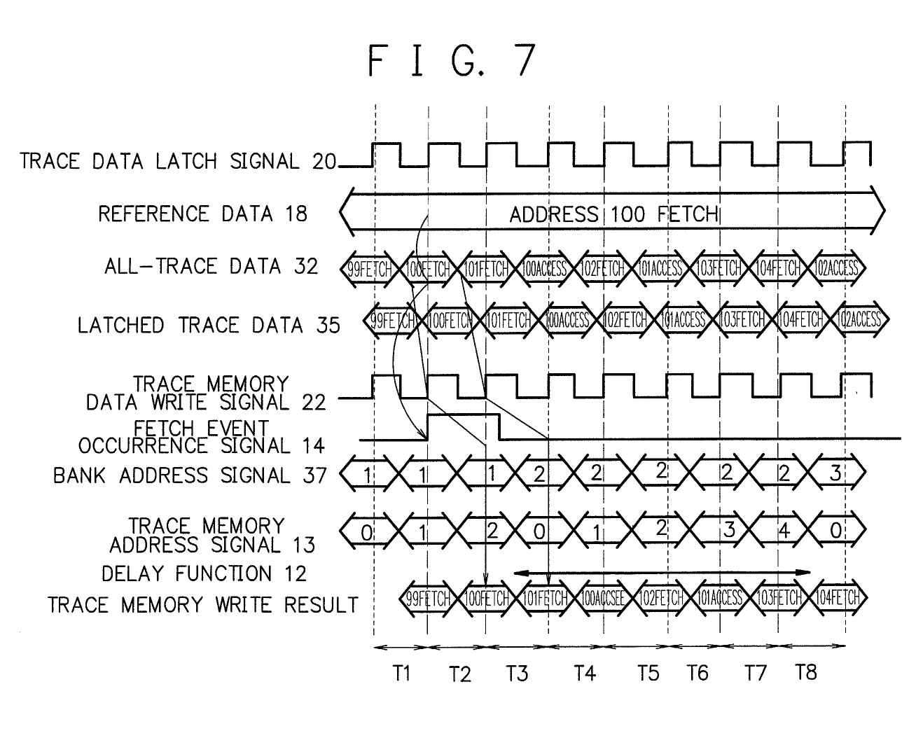

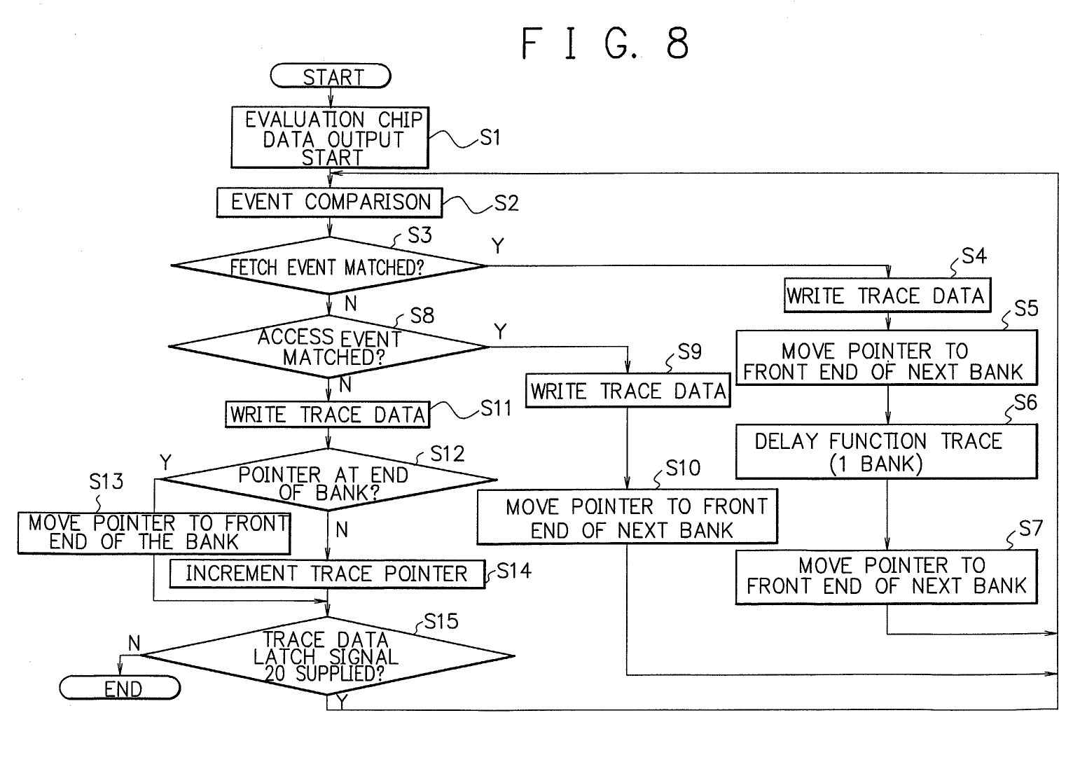

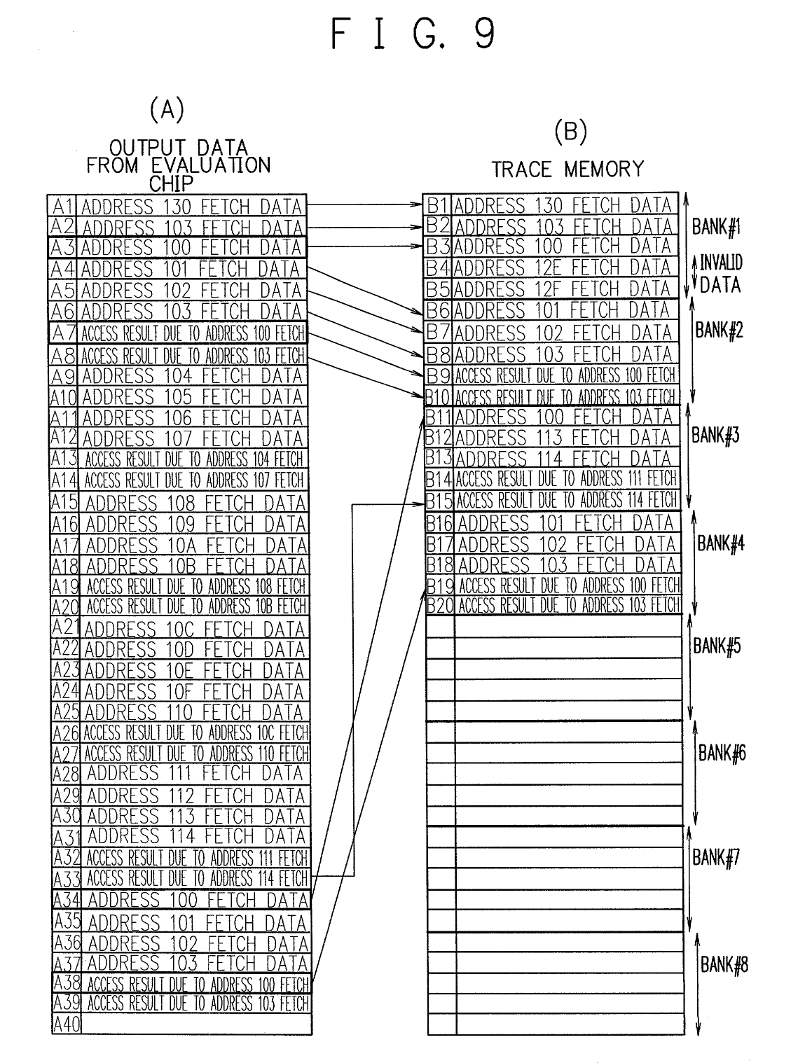

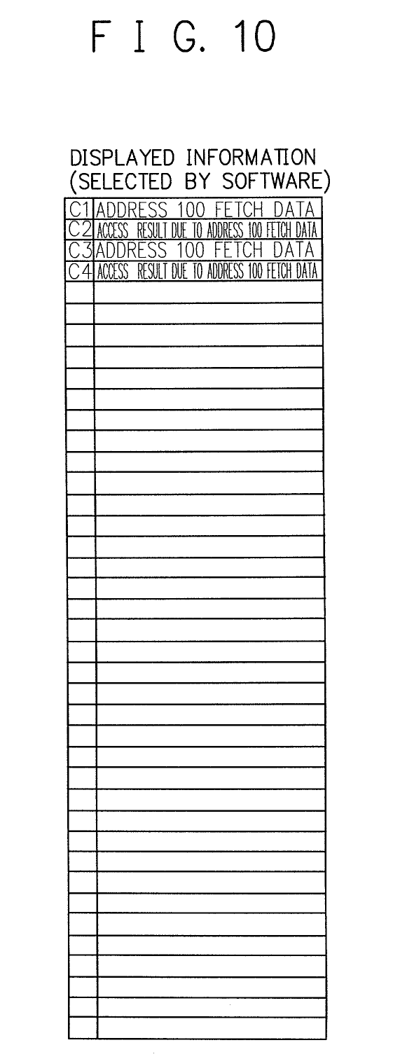

FIG. 6 is a block diagram showing a tracing circuit of an operation monitoring device in accordance with a first embodiment of the present invention. The first embodiment is an example in which the operation monitoring device is an in-circuit emulator. FIG. 7 is a timing chart showing an example of the operation of the tracing circuit of FIG. 6. FIG. 8 is a flow chart showing an example of the operation of the tracing circuit of FIG. 6. FIG. 9 is a schematic diagram showing an example of data output from an evaluation chip and data writing into a trace memory in the tracing circuit of FIG. 6. FIG. 10 is a schematic diagram showing an example of qualify data information which is selected by software and shown to the user of the operation monitoring device (in-circuit emulator).

Referring to FIG. 6, the tracing circuit of the first example includes an evaluation chip 31, a trace address counter controller 38, an event comparison circuit 17, an event reference data setting section 19, a latch 33, a bank counter 36, an address counter 42 and a trace memory 34.

All-trace data 32 outputted by the evaluation chip 31 is inputted to the latch 33 and the event comparison circuit 17. The all-trace data 32 outputted by the evaluation chip 31 includes the aforementioned “fetch data” and “access result”. As mentioned before, the “fetch data” includes a memory address (fetch address) (to which an instruction fetch has been executed) and an instruction code (which has been fetched from the fetch address in the fetch event), for example. The “access result” includes a memory address (to which a read/write access has been executed due to the execution of the instruction code) and data (which has been read/written from/into the memory address), for example.

To the event comparison circuit 17, reference data 18 to be used for event comparison is preliminarily set. As mentioned before, the reference data 18, which is set by the user before the evaluation, can be set with regard to one or more addresses, a specific type of event, a combination of address and event, etc. For example, the reference data 18 to be used for the event comparison includes: “any event with regard to address 100”, “data reading from address 100”, “data writing to address 100”, “instruction fetch from address 100”, “data reading of data AA”, “data writing of data AA”, “data reading/writing of data AA”, etc.

If all-trace data 32 supplied from the evaluation chip 31 matched the preset reference data 18, the event comparison circuit 17 outputs a fetch event occurrence signal 14 (if the matched event is a fetch event) or an access event occurrence signal 15 (if the matched event is an access event) to the trace address counter controller 38. Whether the matched event is a fetch event or an access event can be judged based on whether lines through which the all-trace data 32 has been supplied from the evaluation chip 31 to the event comparison circuit 17 are fetch address lines (lines for transferring fetch addresses) or access address lines (lines for transferring access addresses), for example.

The event reference data setting section 19 is implemented by, for example, a host machine such as a personal computer. The reference data 18 is set to the event comparison circuit 17 by means of register write by the host machine. The evaluation chip 31, the trace address counter controller 38, the event comparison circuit 17, the latch 33, the bank counter 36, the address counter 42 and the trace memory 34 can be implemented by, for example, a microprocessor unit which is composed of a CPU (Central Processing Unit), ROM (Read Only Memory), RAM (Random Access Memory), etc., and appropriate software. Such software for realizing the operation of the tracing circuit is stored in one or more record mediums. The trace memory 34 can be implemented by SRAM (Static RAM).

The latch 33 latches the all-trace data 32 supplied from the evaluation chip 31 in sync with a trace data latch signal 20 which is also supplied from the evaluation chip 31, and outputs the latched trace data 35 to the trace memory 34. The trace address counter controller 38 constantly outputs a trace memory data write signal 22 (which is in sync with the trace data latch signal 20) to the trace memory 34.

The bank counter 36 outputs a bank address signal 37 for designating a bank of the trace memory 34, and the address counter 42 outputs a trace memory address signal 13 for designating an address in a bank of the trace memory 34. The write address (write pointer) to which the latched trace data 35 should be written is determined by a combination of the bank address signal 37 and the trace memory address signal 13 which are currently supplied from the bank counter 36 and the address counter 42 to the trace memory 34. Therefore, when the trace memory data write signal 22 is outputted by the trace address counter controller 38, the latched trace data 35 outputted by the latch 33 is written into an address of a bank of the trace memory 34 that is designated by the currently outputted bank address signal 37 and trace memory address signal 13. The trace memory address signal 13 outputted by the address counter 42 is successively incremented by an increment signal 41 (which is in sync with the trace data latch signal 20) which is supplied from the trace address counter controller 38. When the trace memory address signal 13 reached its preset maximum value, the address counter 42 resets the trace memory address signal 13 to 0. Therefore, when neither the fetch event occurrence signal 14 nor the access event occurrence signal 15 is supplied from the event comparison circuit 17, the trace data writing into a current bank (#1, for example) is repeated cyclically (in a loop).

When the fetch event occurrence signal 14 is supplied from the event comparison circuit 17, latched trace data 35 (corresponding to the matched fetch event) which is outputted by the latch 33 is written into an address of a bank of the trace memory 34 that is currently designated by the bank address signal 37 and the trace memory address signal 13. Subsequently, the trace address counter controller 38 outputs an increment signal 39 and a clear signal 16 to the bank counter 36 and the address counter 42 respectively, thereby the write address (write pointer) of the trace memory 34 is moved into the front end of the next bank (#2, for example). Thereafter, the trace address counter controller 38 keeps on incrementing the trace memory address signal 13 of the address counter 42 by successively outputting the increment signals 41 to the address counter 42 and keeps on outputting the trace memory data write signal 22 to the trace memory 34 until trace data writing throughout the current bank (#2) is finished (delay function). Subsequently, since the delay function has been activated, the trace address counter controller 38 outputs the increment signal 39 and the clear signal 16 to the bank counter 36 and the address counter 42 respectively, thereby the write address (write pointer) of the trace memory 34 is moved into the front end of the next bank (#3) without executing the loop writing to the current bank (#2). Thereafter, in the next bank (#3), the loop writing is repeated while waiting for the occurrence of a designated event (the fetch event occurrence signal 14 or the access event occurrence signal 15).

When the access event occurrence signal 15 is supplied from the event comparison circuit 17, latched trace data 35 (corresponding to the matched access event) which is outputted by the latch 33 is written into an address of a bank of the trace memory 34 that is currently designated by the bank address signal 37 and the trace memory address signal 13. Subsequently, the trace address counter controller 38 outputs the increment signal 39 and the clear signal 16 to the bank counter 36 and the address counter 42 respectively, thereby the write address (write pointer) of the trace memory 34 is moved into the front end of the next bank (#4, for example). In this case (in the case of an access event), the “delay function” is not activated, therefore, the loop writing is repeated in the next bank (#4) while waiting for the occurrence of a designated event (the fetch event occurrence signal 14 or the access event occurrence signal 15). The above trace data writing is continued until the trace data latch signal 20 outputted by the evaluation chip 31 stops.

By the above operation, necessary trace data with regard to a fetch event and an access event corresponding to the fetch event can certainly be preserved in the trace memory 34. The preservation of the fetch event and the access event as a pair can be conducted regardless of whether the user designated a fetch event or an access event.

In the following, the operation of the tracing circuit of FIG. 6 will be described in detail referring to the timing chart of FIG. 7.

Referring to FIG. 7, the all-trace data 32 outputted by the evaluation chip 31 is latched by the latch 33 in sync with rising edges of the trace data latch signal 20 and is outputted as the latched trace data 35. The all-trace data 32, which is also supplied to the event comparison circuit 17, is compared with the reference data 18. If all-trace data 32 (concerning a fetch event) matched the reference data 18, the fetch event occurrence signal 14 (in the case where the matched event is a fetch event) is outputted by the event comparison circuit 17 at the timing T1 shown in FIG. 7. The fetch event occurrence signal 14 is inputted to the trace address counter controller 38. The latched trace data 35 corresponding to the address 100 fetch is written into an address of a bank of the trace memory 34 that is designated by the current bank address signal 37 and the currently incremented trace memory address signal 13 (bank #1, address #2) at the timing T2. At the timing T3, the bank address signal 37 is incremented to 2 (indicating the next bank #2) and the trace memory address signal 13 is cleared to 0, thereby the next trace data (address 101 fetch data) is written into the address #0 of the next bank #2.

Subsequently, the delay function is activated, and thereby the trace memory address signal 13 is successively incremented until the trace data writing throughout the bank #2 is finished. The trace data writing to the bank #2 (address #0˜#4) is completed at the timing T7. At the next timing T8, the bank address signal 37 is incremented to 3 (indicating the next bank #3) and the trace memory address signal 13 is cleared to 0, thereby the next trace data (address 104 fetch data) is written into the address #0 of the next bank #3.

Thereafter, the loop writing is repeated in the current bank #3, while waiting for the occurrence of a designated event.

In the following, the operation of the tracing circuit of FIG. 6 will be described more in detail referring to the flow chart of FIG. 8.

Referring to FIG. 8, when the emulation of a CPU (MPU) by the evaluation chip 31 is started, the evaluation chip 31 starts outputting the all-trace data 32 to the latch 33 and the event comparison circuit 17 (step SI). The all-trace data 32 supplied to the event comparison circuit 17 is compared with the reference data 18 which has been set to the event comparison circuit 17 (step S2).

If all-trace data 32 (concerning a fetch event) outputted by the evaluation chip 31 matched the reference data 18 (“Yes” in step S3), the all-trace data 32 (latched trace data 35) is written into an address of a bank of the trace memory 34 that is currently designated by the bank address signal 37 and the trace memory address signal 13 (step S4). Subsequently, by the increment signal 39 and the clear signal 16 of the trace address counter controller 38, the bank address signal 37 is incremented and the trace memory address signal 13 is cleared to 0, thereby the write address (write pointer) of the trace memory 34 is moved into the front end of the next bank (#2, for example) (step S5). Subsequently, the delay function of the trace address counter controller 38 is activated (step S6).

In the delay function, the trace data writing is conducted from the front end to the rear end of the next bank (#2) once and the loop writing is not executed. Therefore, only the trace memory address signal 13 is incremented during the delay function.

Subsequently, the bank address signal 37 is incremented and the trace memory address signal 13 is cleared to 0 and thereby the write address (write pointer) of the trace memory 34 is moved into the front end of the next bank (#3, for example) (step S7). Thereafter, the process is returned to the step S2 and the event comparison is continued.

If all-trace data 32 (concerning an access event) outputted by the evaluation chip 31 matched the reference data 18 (“Yes” in step S8), the all-trace data 32 (latched trace data 35) is written into an address of a bank of the trace memory 34 that is currently designated by the bank address signal 37 and the trace memory address signal 13 (step S9). Subsequently, by the increment signal 39 and the clear signal 16 of the trace address counter controller 38, the bank address signal 37 is incremented and the trace memory address signal 13 is cleared to 0, thereby the write address (write pointer) of the trace memory 34 is moved into the front end of the next bank (#4, for example) (step S5). In the case where an access event matched, the “delay function” is not activated, and thus the process is returned to the step S2 for event comparison without executing the delay function trace for 1 bank.

If the all-trace data 32 (concerning a fetch event or an access event) outputted by the evaluation chip 31 did not match the reference data 18 (“No” in the step S8), the all-trace data 32 (latched trace data 35) is written into an address of a bank of the trace memory 34 that is currently designated by the bank address signal 37 and the trace memory address signal 13 (step S11), and whether the write address (write pointer) has reached the rear end (the last address) of the current bank (#4, for example) or not is judged (step S12). If the write address (write pointer) has not reached the rear end (“No” in the step S12), the trace memory address signal 13 is incremented (step S14). If the write address (write pointer) has reached the rear end (“Yes” in the step S12), the trace memory address signal 13 is cleared to 0 and thereby the write address (write pointer) of the trace memory 34 is moved into the front end of the current bank (#4) (step S13). Subsequently, whether the trace data latch signal 20 is still supplied from the evaluation chip 31 or not is judged (step S15). If the trace data latch signal 20 is supplied (“Yes” in the step S15), the process is returned to the step S2. If the trace data latch signal 20 has stopped (“No” in the step S15), the process is ended.

In the following, the trace data writing into the trace memory 34 will be described in detail referring to FIG. 9. Incidentally, FIG. 9 shows a case where tracing with regard to a fetch event (address 100 fetch) is executed.

As shown in (A) of FIG. 9, instruction fetches (fetch events) and memory accesses (access events) are successively executed and the all-trace data 32 (including the fetch data concerning the fetch events and the access results concerning the access events) are outputted by the evaluation chip 31 (trace data A1˜A39). The first trace data A1 and A2 are written in (absolute) addresses B1 and B2 of the trace memory 34 as shown in (B) of FIG. 9. When trace data A3 (concerning the address 100 fetch) is outputted by the evaluation chip 31, the fetch event occurrence signal 14 is outputted by the event comparison circuit 17. Therefore, the trace data A3 (address 100 fetch data) is written into the addresses B3 and thereafter the write address (write pointer) of the trace memory 34 is moved into the front end of the next bank (#2 of FIG. 9). Since the matched event is a fetch event, the delay function of the trace address counter controller 38 is activated and the 1 bank delay function trace for the current bank #2 is executed, thereby trace data A4, A5, A6, A7 and A8 outputted by the evaluation chip 31 are written into the addresses B6, B7, B8, B9 and B10 of the trace memory 34 respectively. Incidentally, the trace data which are seen in the addresses B4 and B5 of the trace memory 34 are invalid data which have been written during the previous loop before the output of the trace data A1.

Subsequently, by the increment signal 39 and the clear signal 16 of the trace address counter controller 38, the write address (write pointer) of the trace memory 34 is moved into the front end of the next bank #3. Trace data A9˜A33 from the evaluation chip 31 are successively written in the current bank #3 in a loop. In the loop writing, the trace data A9˜A29 are deleted by the overwriting.

After trace data A30, A31, A32 and A33 from the evaluation chip 31 have been written into the addresses B12, B13, B14 and B15 of the trace memory 34, trace data A34 concerning the designated fetch event (address 100 fetch) is outputted from the evaluation chip 31 and the fetch event occurrence signal 14 is outputted by the event comparison circuit 17. Therefore, the trace data A34 (address 100 fetch data) is written into the addresses B11 of the current bank #3 and thereafter the write address (write pointer) of the trace memory 34 is moved into the front end of the next bank #4. Since the matched event is a fetch event, the delay function of the trace address counter controller 38 is activated and the 1 bank delay function trace for the current bank #4 is executed, thereby trace data A35, A36, A37, A38 and A39 outputted by the evaluation chip 31 are written into the addresses B16, B17, B18, B19 and B20 of the trace memory 34 respectively. After the delay function trace, the write address (write pointer) of the trace memory 34 is moved into the front end of the next bank #5. In the bank #5, the loop writing is conducted while waiting for the occurrence of the designated event.

FIG. 10 shows an example of qualify data information which is selected by software and shown to the user of the in-circuit emulator. As shown in FIG. 10, the software of the in-circuit emulator selects the trace data stored at the addresses B3, B9, B11 and B19 from the all-trace data remaining in the trace memory 34 (as fetch data concerning the address 100 fetches (address 100 fetch data) and access results concerning the address 100 fetches), and displays the selected trace data to the user.

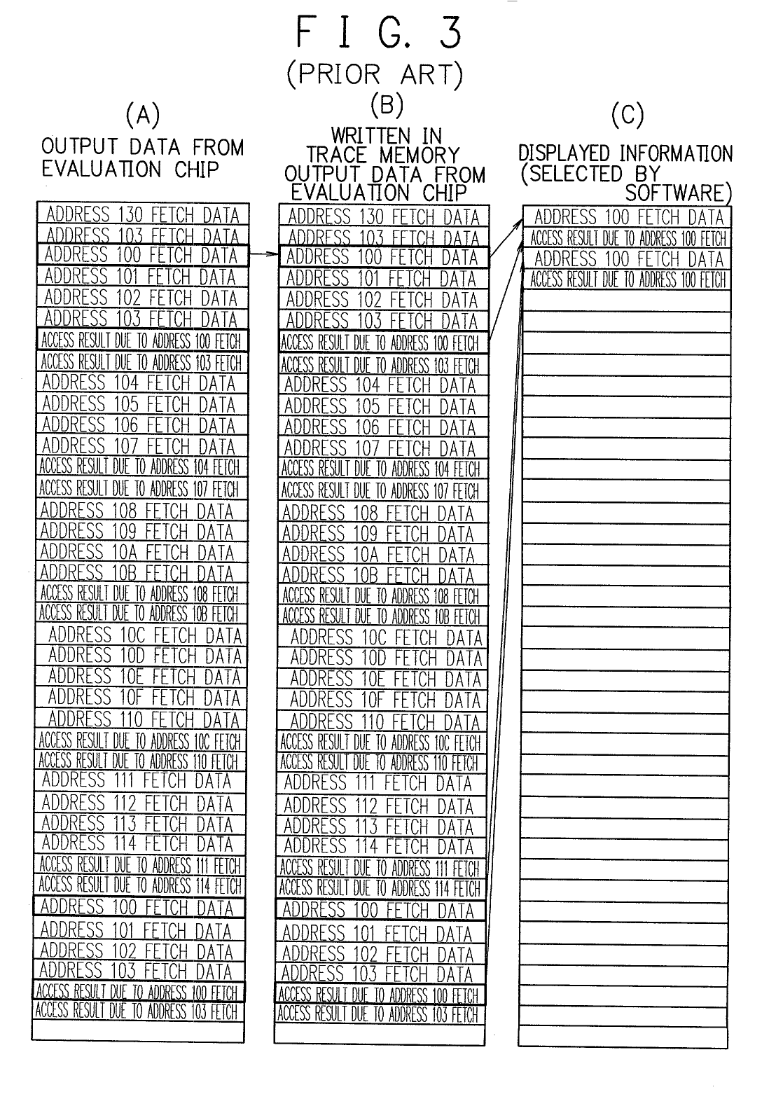

In the above example of FIG. 9, the tracing could be conducted by use of 20 frames (addresses B1˜B20) of the trace memory 34, whereas 39 frames (addresses B1˜B39) were necessary in the case of the conventional all trace of FIG. 3. Therefore, memory consumption could be reduced to half in the above example in accordance with the present invention.

As described above, in the tracing circuit of an operation monitoring device and the tracing method for an operation monitoring device in accordance with the first embodiment of the present invention, both all-trace data 32 concerning “prior events” (events before a designated event) and all-trace data 32 concerning “posterior events” (events after a designated event) can be preserved in the trace memory 34 without being deleted by the overwriting even when the pipeline processing is executed by the CPU. Memory consumption can be reduced considerably in comparison with the conventional all trace.

Concretely, when the user of the operation monitoring device (in-circuit emulator) designated an access event as an object of tracing, both trace data (access result) concerning the designated access event and trace data (fetch data) concerning a fetch event corresponding to the designated access event can be preserved in the trace memory 34 without being deleted by the overwriting. On the other hand, when the user designated a fetch event as an object of tracing, both trace data (fetch data) concerning the designated fetch event and trace data (access result) concerning an access event corresponding to the designated fetch event can be preserved in the trace memory 34 without being deleted by the overwriting. In short, trace data (fetch data) concerning a fetch event and trace data (access result) concerning a corresponding access event can certainly be preserved in the trace memory 34 and displayed to the user as a pair even when the pipeline processing is executed by the CPU, regardless of whether the user designated a fetch event or an access event.

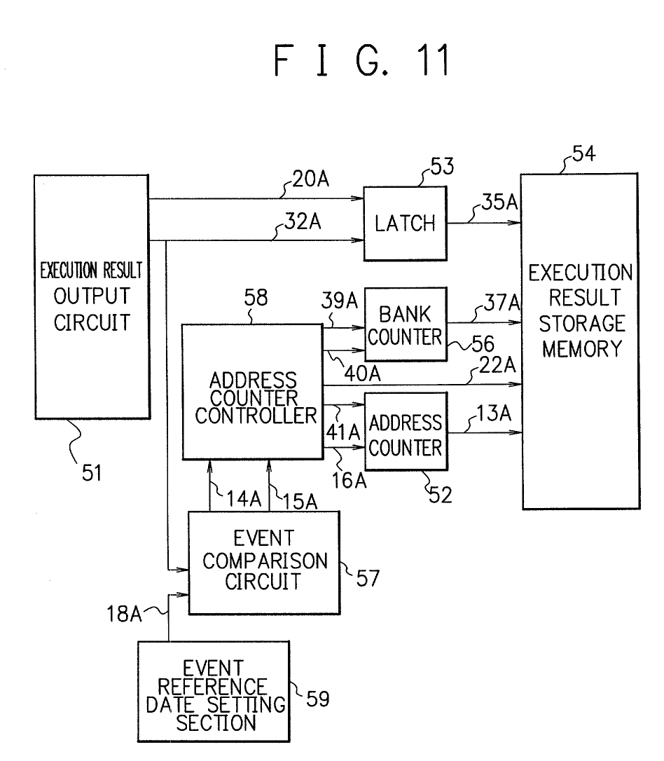

FIG. 11 is a block diagram showing a tracing circuit of an operation monitoring device in accordance with a second embodiment of the present invention. The second embodiment is an example in which the operation monitoring device is a logic analyzer.

Referring to FIG. 11, the tracing circuit of the second embodiment includes an execution result output circuit 51, an address counter controller 58, an event comparison circuit 57, an event reference data setting section. 59, a latch 53, a bank counter 56, an address counter 52 and an execution result storage memory 54. The execution result output circuit 51, the address counter controller 58, the event comparison circuit 57, the event reference data setting section 59, the latch 53, the bank counter 56, the address counter 52 and the execution result storage memory 54 of the second embodiment are parts that correspond to the evaluation chip 31, the trace address counter controller 38, the event comparison circuit 17, the event reference data setting section 19, the latch 33, the bank counter 36, the address counter 42 and the trace memory 34 of the first embodiment, respectively.

Execution result data 32A outputted by the execution result output circuit 51 is inputted to the latch 53 and the event comparison circuit 57. The execution result data 32A is latched by the latch 53 and the latched execution result data 35A is written in the execution result storage memory 54. The execution result data 32A and the latched execution result data 35A of the second embodiment correspond to the all-trace data 32 and the latched trace data 35 of the first embodiment, respectively. The execution result storage memory 54 is segmented into several banks #1, #2, . . . , in the same way as the trace memory 34 of the first embodiment.

In the second embodiment, words “prior-preservation event” and “posterior-preservation event” will be used. Both the prior-preservation event and the posterior-preservation event are events which are designated by the user of the logic analyzer to be traced in the execution result storage memory 54. Therefore, execution result data 32A (latched execution result data 35A) concerning the prior-preservation event and the posterior-preservation event are stored in the execution result storage memory 54. When the user intends to preserve execution result data 32A concerning events before the designated event, the designated event is set to the event comparison circuit 57 as a prior-preservation event. On the other hand, when the user intends to preserve execution result data 32A concerning events after the designated event, the designated event is set to the event comparison circuit 57 as a posterior-preservation event. Therefore, the “prior-preservation event” and the “posterior-preservation event” in the second embodiment correspond to the “(designated) access event” and the “(designated) fetch event” in the first embodiment, respectively.

If we assume a prior-preservation event and a posterior-preservation event have been designated by the user of the operation monitoring device (logic analyzer) and set (as objects of tracing) to the event comparison circuit 57, when execution result data 32A that matches the designated prior-preservation event occurred, a prior-preservation event occurrence signal (trigger signal) 15A is outputted by the event comparison circuit 57. In the case where the prior-preservation event occurrence signal 15A is supplied to the address counter controller 58, the latched execution result data 35A corresponding to the designated prior-preservation event is written into the current bank (#1, for example) of the execution result storage memory 54 and thereafter the write address (write pointer) for the next execution result data 32A is moved to the front end of the next, bank (#2). Thereafter, the loop writing into the current bank (#2) is repeated while waiting for the occurrence of a designated event.

When execution result data 32A that matches the designated posterior-preservation event occurred, a posterior-preservation event occurrence signal (trigger signal) 14A is outputted by the event comparison circuit 57. In the case where the posterior-preservation event occurrence signal 14A is supplied to the address counter controller 58, the latched execution result data 35A corresponding to the designated posterior-preservation event is written into the current bank (#2) of the execution result storage memory 54 and thereafter the write address (write pointer) for the next execution result data 32A is moved to the front end of the next bank (#3). Thereafter, the execution result data writing into the current bank (#3) is continued to the rear end of the current bank (#3), and thereafter the write address (write pointer) for the next trace data is moved to the front end of the next bank (#4), without executing the loop writing to the current bank (#3) (delay function).

In the above operation including the “delay function”, execution result data 32A concerning events before the occurrence of the designated prior-preservation event could be preserved in the bank #1 of the execution result storage memory 54 without being deleted, and execution result data 32A concerning events after the occurrence of the designated posterior-preservation event could be preserved in the bank #3 of the execution result storage memory 54 without being deleted.

As described above, in the tracing circuit of an operation monitoring device and the tracing method for an operation monitoring device in accordance with the second embodiment of the present invention, effects similar to those of the first embodiment can be obtained. Concretely, both execution result data 32A concerning “prior events” (events before a designated event) and execution result data 32A concerning “posterior events” (events after a designated event) can be preserved in the execution result storage memory 54 without being deleted by the overwriting even when the pipeline processing is executed by the CPU. Memory consumption can be reduced considerably in comparison with the conventional all trace.

More concretely, when the user of the operation monitoring device (logic analyzer) designated a prior-preservation event as an object of tracing, both trace data (execution result data 32A) concerning the designated prior-preservation event and trace data (execution result data 32A) concerning the “prior events” can certainly be preserved in the execution result storage memory 54 without being deleted by the overwriting. On the other hand, when the user designated a posterior-preservation event as an object of tracing, both trace data (execution result data 32A) concerning the designated posterior-preservation event and trace data (execution result data 32A) concerning the “posterior events” can certainly be preserved in the execution result storage memory 54 without being deleted by the overwriting. In short, trace data (execution result data 32A) concerning a designated event and trace data (execution result data 32A) concerning a corresponding prior/posterior event can certainly be preserved in the execution result storage memory 54 and displayed to the user as a pair even when the pipeline processing is executed by the CPU, regardless of whether the user designated a prior-preservation event or a posterior-preservation event.

As set forth hereinabove, in the tracing circuit of an operation monitoring device and the tracing method for an operation monitoring device in accordance with the present invention, both trace data (all-trace data 32, execution result data 32A, etc.) concerning “prior events” (events before a designated event) and trace data (all-trace data 32, execution result data 32A, etc.) concerning “posterior events” (events after a designated event) can be preserved in the trace memory (trace memory 34, execution result storage memory 54, etc.) even when the pipeline processing is executed by the CPU. Memory consumption can be reduced considerably in comparison with the conventional all trace.

Concretely, in the case of the in-circuit emulator, fetch data and access result corresponding to the fetch data can certainly be traced and displayed as a pair even when the pipeline processing is executed by the CPU, without the need of a large storage capacity of the trace memory 34. In the case of the logic analyzer, execution result data 32A concerning a designated event and execution result data 32A concerning a corresponding prior/posterior event can be traced and displayed as a pair even when the pipeline processing is executed by the CPU, without the need of a large storage capacity of the execution result storage memory 54.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

What is claimed is:

1. A tracing circuit of an operation monitoring device, comprising:
a trace data output means for outputting trace data;
a trace memory means which is partitioned into banks of appropriate sizes and into which the trace data outputted by the trace data output means is written;
a reference data storage means for storing reference data corresponding to a prior-preservation event and/or a posterior-preservation event which have been designated by the user of the operation monitoring device as objects of tracing;
an event comparison means for comparing the trace data outputted by the trace data output means with the reference data corresponding to the prior-preservation event and/or the reference data corresponding to the posterior-preservation event, outputting a prior-preservation event occurrence signal if the trace data matched the reference data corresponding to the prior-preservation event, and outputting a posterior-preservation event occurrence signal if the trace data matched the reference data corresponding to the posterior-preservation event; and
a trace address control means for controlling the write address of the trace memory means so that trace data writing will be conducted to the current bank of the trace memory means cyclically by returning the write address to the front end of the current bank when the write address reached the rear end of the current bank, wherein:
when the prior-preservation event occurrence signal is outputted by the event comparison means, the trace address control means moves the write address of the trace memory means to the front end of another bank after the trace data corresponding to the prior-preservation event occurrence signal is written into the current bank of the trace memory means, and
when the posterior-preservation event occurrence signal is outputted by the event comparison means, the trace address control means moves the write address of the trace memory means to the front end of another bank (#A) after the trace data corresponding to the posterior-preservation event occurrence signal is written into the current bank of the trace memory means, and moves the write address to the front end of still another bank (#B) if the trace data writing is finished throughout the aforementioned another bank (#A).

2. A tracing circuit as claimed in claim 1, wherein the operation monitoring device is implemented as an in-circuit emulator (ICE), and the trace data output means is implemented as an evaluation chip of the in-circuit emulator.

3. A tracing circuit as claimed in claim 2, wherein the prior-preservation event is an access event, and the posterior-preservation event is a fetch event.

4. A tracing circuit as claimed in claim 1, wherein the operation monitoring device is implemented as a logic analyzer, and the trace data output means is implemented as an execution result output circuit of the logic analyzer.

5. A tracing circuit as claimed in claim 1, wherein the trace data outputted by the trace data output means is latched by a latch in sync with a signal which is outputted by the trace data output means, and the latched trace data is written into the trace memory means.

6. A tracing method for an operation monitoring device, comprising the steps of:
a reference data storage step in which reference data corresponding to a prior-preservation event and/or a posterior-preservation event which have been designated by the user of the operation monitoring device as objects of tracing are stored in a reference data storage means;
a trace memory partitioning step in which a trace memory means into which trace data outputted by a trace data output means are written is partitioned into banks of appropriate sizes;
a trace data output step in which the trace data is outputted by the trace data output means;
an event comparison step in which the trace data outputted by the trace data output means is compared with the reference data corresponding to the prior-preservation event and/or the reference data corresponding to the posterior-preservation event, a prior-preservation event occurrence signal is outputted if the trace data matched the reference data corresponding to the prior-preservation event, and a posterior-preservation event occurrence signal is outputted if the trace data matched the reference data corresponding to the posterior-preservation event;
a first trace address control step in which the write address of the trace memory means is controlled so that trace data writing will be conducted to the current bank of the trace memory means cyclically by returning the write address to the front end of the current bank when the write address reached the rear end of the current bank;
a second trace address control step which is conducted when the prior-preservation event occurrence signal is outputted in the event comparison step, in which the write address of the trace memory means is moved to the front end of another bank after the trace data corresponding to the prior-preservation event occurrence signal is written into the current bank of the trace memory means; and
a third trace address control step which is conducted when the posterior-preservation event occurrence signal is outputted in the event comparison step, in which the write address of the trace memory means is moved to the front end of another bank (#A) after the trace data corresponding to the posterior-preservation event occurrence signal is written into the current bank of the trace memory means, and the write address is moved to the front end of still another bank (#B) if the trace data writing is finished throughout the aforementioned another bank (#A).

7. A tracing method as claimed in claim 6, wherein the operation monitoring device is implemented as an in-circuit emulator (ICE), and the trace data output means is implemented as an evaluation chip of the in-circuit emulator.

8. A tracing method as claimed in claim 7, wherein the prior-preservation event is an access event, and the posterior-preservation event is a fetch event.

9. A tracing method as claimed in claim 6, wherein the operation monitoring device is implemented as a logic analyzer, and the trace data output means is implemented as an execution result output circuit of the logic analyzer.

10. A tracing method as claimed in claim 6, wherein the trace data outputted by the trace data output means in the trace data output step is latched in sync with a signal which is outputted by the trace data output means, and the latched trace data is written into the trace memory means.

11. A computer-readable record medium storing a program for instructing a computer, an MPU (MicroProcessor Unit), etc. to execute a tracing process for an operation monitoring device, wherein the tracing process includes the steps of:
a reference data storage step in which reference data corresponding to a prior-preservation event and/or a posterior-preservation event which have been designated by the user of the operation monitoring device as objects of tracing are stored in a reference data storage means;
a trace memory partitioning step in which a trace memory means into which trace data outputted by a trace data output means are written is partitioned into banks of appropriate sizes;
a trace data output step in which the trace data is outputted by the trace data output means;
an event comparison step in which the trace data outputted by the trace data output means is compared with the reference data corresponding to the prior-preservation event and/or the reference data corresponding to the posterior-preservation event, a prior-preservation event occurrence signal is outputted if the trace data matched the reference data corresponding to the prior-preservation event, and a posterior-preservation event occurrence signal is outputted if the trace data matched the reference data corresponding to the posterior-preservation event;
a first trace address control step in which the write address of the trace memory means is controlled so that trace data writing will be conducted to the current bank of the trace memory means cyclically by returning the write address to the front end of the current bank when the write address reached the rear end of the current bank;
a second trace address control step which is conducted when the prior-preservation event occurrence signal is outputted in the event comparison step, in which the write address of the trace memory means is moved to the front end of another bank after the trace data corresponding to the prior-preservation event occurrence signal is written into the current bank of the trace memory means; and
a third trace address control step which is conducted when the posterior-preservation event occurrence signal is outputted in the event comparison step, in which the write address of the trace memory means is moved to the front end of another bank (#A) after the trace data corresponding to the posterior-preservation event occurrence signal is written into the current bank of the trace memory means, and the write address is moved to the front end of still another bank (#B) if the trace data writing is finished throughout the aforementioned another bank (#A).

12. A computer-readable record medium as claimed in claim 11, wherein the operation monitoring device is implemented as an in-circuit emulator (ICE), and the trace data output means is implemented as an evaluation chip of the in-circuit emulator.

13. A computer-readable record medium as claimed in claim 12, wherein the prior-preservation event is an access event, and the posterior-preservation event is a fetch event.

14. A computer-readable record medium as claimed in claim 11, wherein the operation monitoring device is implemented as a logic analyzer, and the trace data output means is implemented as an execution result output circuit of the logic analyzer.

15. A computer-readable record medium as claimed in claim 11, wherein the trace data outputted by the trace data output means in the trace data output step is latched in sync with a signal which is outputted by the trace data output means, and the latched trace data is written into the trace memory means.
